(19) United States
(12) Patent Application Publication
(10) Pub. No.: US 2026/0161332 A1
(43) Pub. Date: Jun. 11, 2026

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventors: Naoto YAMASAKI, Kanagawa (JP); Bo LIU, Kanagawa (JP)

(73) Assignee: FUJIFILM Business Innovation Corp., Tokyo (JP)

(21) Appl. No.: 19/211,465

(22) Filed: May 19, 2025

(30) Foreign Application Priority Data
Dec. 11, 2024 (JP) 2024-217074

(51) Int. Cl. G06F 3/12

(52) U.S. Cl. CPC G06F 3/1208; G06F 3/1256

(57) ABSTRACT

An information processing system includes a processor configured to: display, on a display, procedure information indicating a processing procedure including multiple processing steps to process an object and processing-completion information indicating a product obtained when the processing procedure is performed on the object; and when an instruction is input for one piece of the procedure information and the processing-completion information displayed on the display, change, in conjunction with the inputting, the other piece of the procedure information and the processing-completion information displayed on the display.

### CROSS-REFERENCE TO RELATED APPLICATIONS

This application is based on and claims priority under 35 USC 119 from Japanese Patent Application No. 2024-217074 filed Dec. 11, 2024.

### BACKGROUND

### (i) Technical Field

The present disclosure relates to an information processing system, a non-transitory computer readable medium and an information processing method.

### (ii) Related Art

Japanese Unexamined Patent Application Publication No. 2020-149590 discloses an information processing apparatus including a production unit, first receiving unit, first preview display, second receiving unit and second preview display. On a per type of product, the production unit generates a workflow including multiple work steps to generate a product. The first receiving unit receives a setting of a parameter in each work step in response to a user operation. The first preview display displays a preview using predetermined dummy data and the setting received by the first receiving unit. The second receiving unit receives a designate of a single original document datum from multiple original document data. The second preview display displays a preview with the original document datum received by the second receiving unit replaced with the dummy data.

Information to be displayed on a display may be configured to include procedure information and processing-completion information. The procedure information indicates a processing procedure including multiple processing steps (such as steps of attaching barcode, water mark, page number or the like and step of imposition) used to process an object (such as a print image to be printed). The processing-completion information indicates a product obtained when the processing procedure is performed on the object.

One piece of the procedure information and the processing-completion information displayed on the display may be unable to be changed without inputting an instruction for the one piece of the procedure information and the processing-completion information, and in such a case, in order to change the other piece of the procedure information and the processing-completion information with the one piece displayed on the display, an instruction is to be input for the other piece.

### SUMMARY

Aspects of non-limiting embodiments of the present disclosure relate to easily changing the other piece of the procedure information and the processing-completion information displayed on the display while confirming the one piece of the procedure information and the processing-completion information in comparison with the case in which the one piece displayed on the display is unable to be changed without inputting an instruction for the one piece.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: display, on a display, procedure information indicating a processing procedure including multiple processing steps to process an object and processing-completion information indicating a product obtained when the processing procedure is performed on the object; and when an instruction is input for one piece of the procedure information and the processing-completion information displayed on the display, change, in conjunction with the inputting, the other piece of the procedure information and the processing-completion information displayed on the display.

### BRIEF DESCRIPTION OF THE DRAWINGS

Exemplary embodiments of the present disclosure will be described in detail based on the following figures, wherein:

FIG. 1 illustrates an example of the hardware configuration of an information processing system in an exemplary embodiment;

FIG. 2 is a block diagram illustrating an example of the functional configuration of an information processing apparatus in the exemplary embodiment;

FIG. 3 is a flowchart illustrating a procedure of an information processing process performed by the information processing system in the exemplary embodiment;

FIG. 4 illustrates an example of a production screen displayed on a display in the exemplary embodiment;

FIG. 5 illustrates the production screen illustrated in FIG. 4 with output data displayed;

FIG. 6 illustrates the production screen illustrated in FIG. 5 when a user selects a page number attaching step is selected;

FIG. 7 illustrates the production screen illustrated in FIG. 5 when the user has selected an imposition step;

FIG. 8 illustrates the production screen illustrated in FIG. 5 when the user has provided a delete instruction to delete the first page on a print image of the output data;

FIG. 9 illustrates the production screen illustrated in FIG. 5 when the first page of the print image of the output data is deleted with a delete step added to a workflow;

FIG. 10 illustrates the production screen illustrated in FIG. 5 when the user has provided an insert instruction to insert blank paper subsequent to the first page of the print image of the output data;

FIG. 11 illustrates the production screen illustrated in FIG. 5 when the blank paper is inserted subsequent to the first page of the print image of the output data with a blank paper insert step added to the workflow;

FIG. 12 illustrates the production screen illustrated in FIG. 5 when the user has provided an instruction to change the position of a barcode; and

FIG. 13 illustrates the production screen illustrated in FIG. 5 when the user has provided an instruction to delete the page number on the first page of the print image.

### DETAILED DESCRIPTION

Exemplary embodiments of the present disclosure are described with reference to the drawings.

### Information Processing System 10

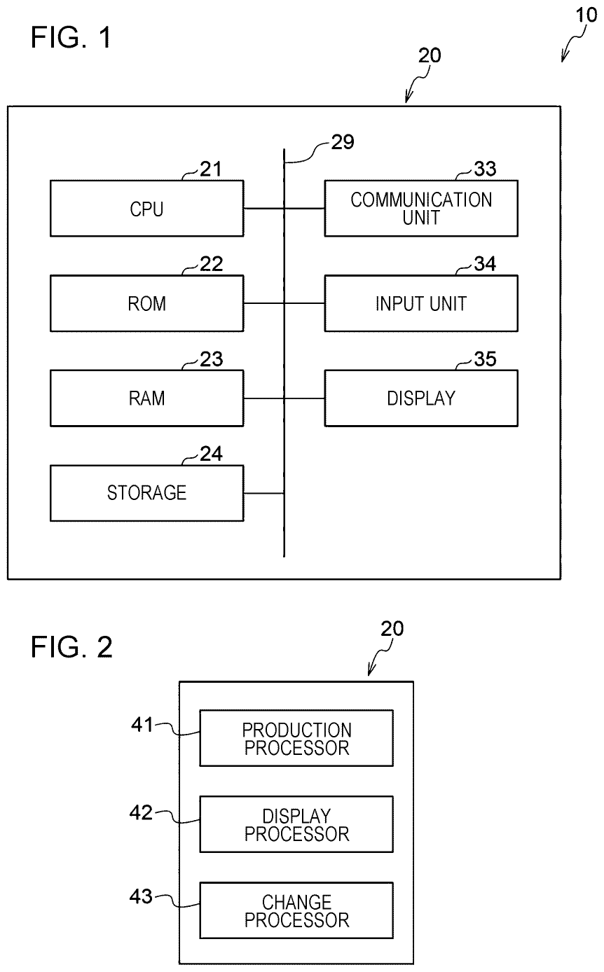

Information processing system 10 of an exemplary embodiment is described below. FIG. 1 is a block diagram illustrating an example of the hardware configuration of the information processing system 10.

The information processing system 10 illustrated in FIG. 1 performs a predetermined information processing process. According to the exemplary embodiment, the information processing system 10 performs a production operation that produces a workflow in a pre-process of printing. The information processing system 10 also performs a display operation that displays workflow data indicating the produced workflow and image data of a print image when the workflow is performed on original document data. When an instruction is input for one piece of the workflow data and the image data, the information processing system 10 also performs in conjunction with the inputting a change operation that changes the other piece of the workflow data and the image data.

The information processing system 10 includes, for example, an information processing apparatus 20. The information processing apparatus 20 may be a general-purpose computer, such as a server computer or a personal computer.

The information processing apparatus 20 has a function of a computer and includes, as illustrated in FIG. 1, a central processing unit (CPU) 21, read-only memory (ROM) 22, random-access memory (RAM) 23, storage 24, communication unit 33, input unit 34 and display 35.

The CPU 21, ROM 22, RAM 23, storage 24, communication unit 33, input unit 34 and display 35 are interconnected to each other via a connection line 29. The information processing system 10 may include a single information processing apparatus 20 or multiple information processing apparatuses 20. The process performed by the information processing apparatus 20 may thus be performed by the multiple information processing apparatuses 20.

The communication unit 33 is a communication interface and is thus configured to communicate with the other apparatus. Specifically, the communication unit 33 communicates with the other apparatus via at least one of a wired communication line or a wireless communication line.

The other apparatus may be a providing apparatus that provides the information processing apparatus 20 with image information representing a print image. The other apparatus may be a converter that converts image data obtained when the information processing apparatus 20 has performed the workflow on the image data having undergone the workflow into image data which a printer is able to print. If the information processing apparatus 20 is able to convert the image data having undergone the workflow into the image data that is printable by a printer, the other apparatus may be the printer.

The input unit 34 is configured to receive an instruction from a user. Specifically, the input unit 34 includes input keys (such as a keyboard, mouse and operation button) with which the user performs an input action. The user is a user of the information processing system 10.

The display 35 notifies the user of presentation information by displaying the presentation information for the user on the display 35. The display 35 is, for example, a liquid-crystal display or an organic electroluminescence (EL) display. A variety of screens may be displayed on the display 35.

The display 35 may operate as the input unit 34. In such a case, the input unit 34 is configured to include a touch panel of a resistive membrane system or an electrostatic capacitance system and receives an instruction from the user when the user performs a touch operation.

The CPU 21 is an arithmetic processing unit and executes a variety of programs including an information processing program and controls each unit in the information processing apparatus 20. The ROM 22 stores the variety of programs including the information processing program and a variety of data. The RAM 23 operating as a working area stores temporarily programs and data. The storage 24 includes a recording medium, such as a hard-disk drive (HDD), solid-state drive (SSD) or flash memory and stores a variety of programs including an operating system and a variety of data. The information processing program may also be stored on the storage 24.

The CPU 21 in the information processing apparatus 20 retrieves the variety of programs including the information processing program from the ROM 22 or the storage 24 and executes the programs using the RAM 23 as a working area. A variety of functions are implemented by the CPU 21 that executes the information processing program. As described below, a functional configuration is implemented when the CPU 21 serving as a hardware resource and the information processing program serving as a software resource operate in concert with each other. FIG. 2 is a block diagram illustrating an example of the functional configuration of the information processing apparatus 20 of the exemplary embodiment.

The CPU 21 in the information processing apparatus 20 operates as a production processor 41, display processor 42 and change processor 43 as illustrated in FIG. 2 when the CPU 21 executes the information processing program.

The production processor 41 performs a workflow production operation that produces a workflow in a pre-process of printing. According to the exemplary embodiment, the “workflow” is a procedure of a process in a prepress and includes multiple treatment steps to process a print image. The print image serves as an example of an object. The treatment step is an example of a processing step. The workflow is an example of a processing procedure.

The “production of the workflow” is not limited to the case in which the workflow is produced from scratch and also includes other cases, for example, a case in which a produced workflow is retrieved from the storage 24 and then edited. A specific workflow production operation (step S101) is described below.

The display processor 42 performs a display operation (step S103 described below). In the display operation as described below, the display processor 42 displays a preview of image data (also referred to as output data) of the print image when the produced workflow is performed on original document data. The processed print image is an example of a processed product. The output data is an example of the processing-completion information.

When the user has input an instruction for one piece of the workflow data and the output data displayed on the display 35, the change processor 43 performs a change operation (step S105 described below) to change the other piece of the workflow data and the output data. The change operation is specifically described below.

### Information Processing Process of Exemplary Embodiment

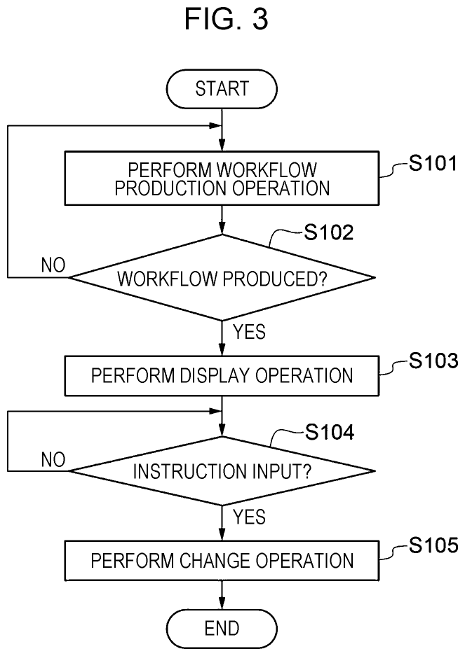

An example of an information processing process performed by the information processing system 10 is described below. FIG. 3 is a flowchart illustrating a procedure of the information processing process performed by the information processing system 10.

The CPU 21 starts performing the information processing process when the CPU 21 has received a production instruction of the workflow from the user. As illustrated in FIG. 3, the CPU 21 performs the workflow production operation (step S101).

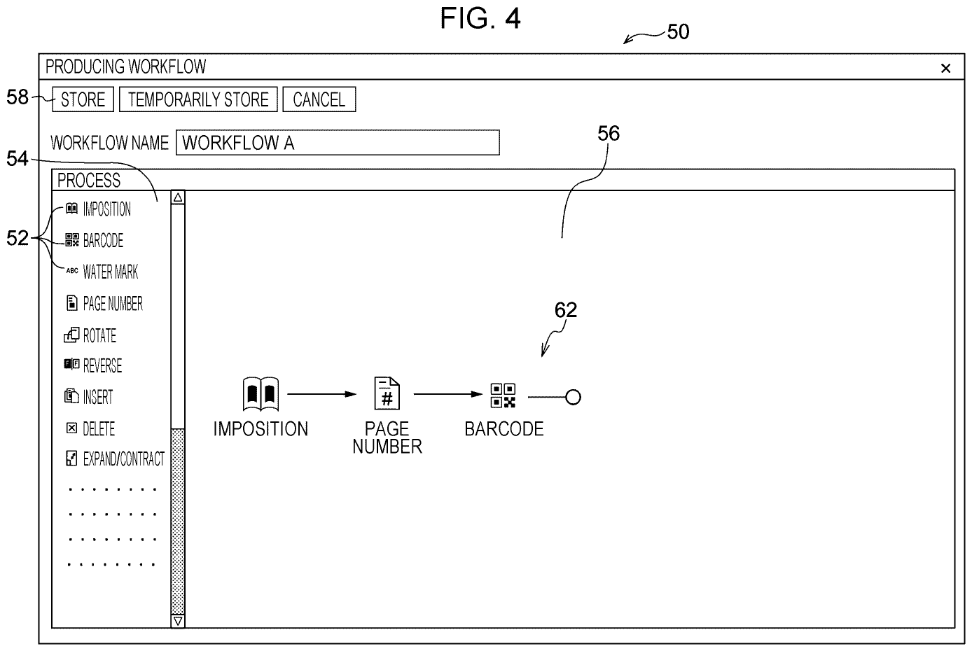

The CPU 21 displays a production screen 50 (see FIG. 4) on the display 35 in the workflow production operation. FIG. 4 illustrates an example of the production screen 50 displayed on the display 35. When the user enters the instruction on the production screen 50 in the workflow production operation, the CPU 21 produces the workflow in response to the instruction.

The left-end portion of the production screen 50 serves as an icon list 54 where treatment icons 52 are displayed. The treatment icons 52 are arranged vertically in the icon list 54.

The treatment icons 52 respectively represent various treatment steps forming the workflow. In the production screen 50 illustrated in FIG. 4, the treatment icons 52 includes icons indicating treatment steps, such as imposition, attaching barcode, attaching watermark, attaching page number, rotate, reverse, insert, delete and expand/contract.

The imposition step is used to impose the pages of print images in a predetermined order. The barcode attachment step, watermark attachment step and page number attachment step attach a barcode, watermark and page number to the print image. The rotate step, reverse step, insert step, delete and expand/contract step respectively rotate, reverse, insert, delete and expand/contact a predetermined page of the print images.

The right-end portion opposite to the icon list 54 on the production screen 50 serves as a workflow production region 56. For example, the CPU 21 produces the workflow when the user, by using the input unit 34, inputs an input instruction that moves the treatment icons 52 from the icon list 54 to the workflow production region 56 and then arranges the treatment icons 52. The input action to move the treatment icons 52 may be a drag and drop operation using a mouse or the like.

FIG. 4 illustrates the workflow that performs the imposition operation, watermark attachment operation and barcode attachment operation in that order.

Referring to FIG. 3, the CPU 21 determines whether the workflow has been produced (step S102). Specifically, when the input instruction to move the treatment icons 52 from the icon list 54 to the workflow production region 56 has been input, the CPU 21 determines that the workflow has been produced. Specifically, the CPU 21 performs determination depending on whether the input instruction has been input.

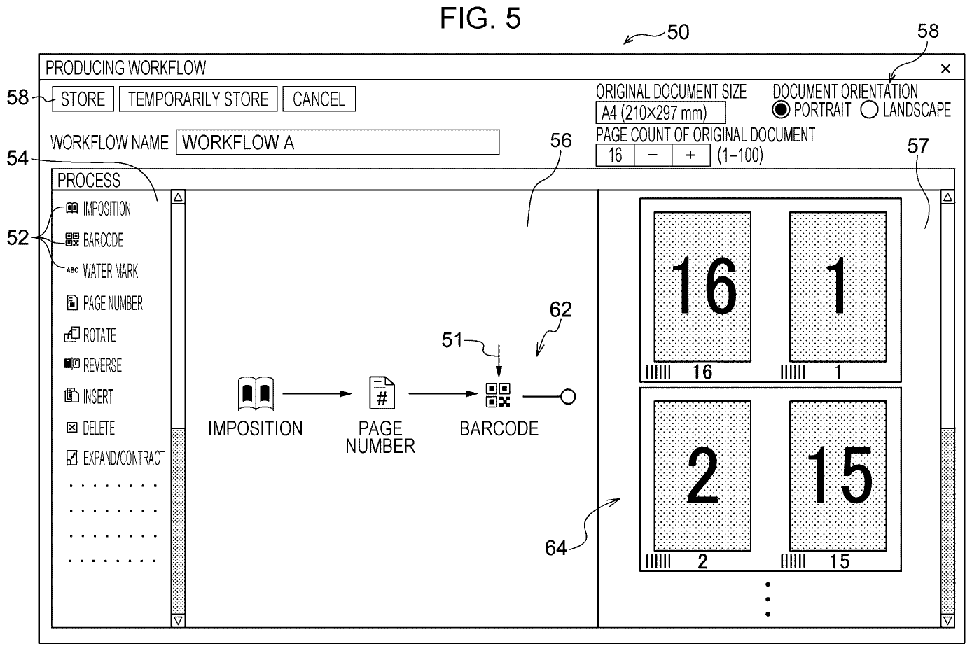

Upon determining that the workflow has been produced (yes in step S102), the CPU 21 performs the display operation (step S103). In the display operation, the CPU 21 displays in the workflow production region 56 workflow data 62 indicating the produced workflow. The CPU 21 furthermore previews the output data 64 of the print image when the produced workflow has been performed on the original document data. Referring to FIG. 5, the output data 64 is displayed in an output data display region 57 created on the right portion of the workflow production region 56. The original document data is image date of the print image on which the workflow is to be performed. The original document data is pre-stored on the information processing system 10.

The production screen 50 includes a setting region 58 on which the user performs a setting on the original document data. The user may set the size, orientation and the number of pages of the original document data in the setting region 58.

Upon determining that the workflow has not been produced (no in step S102), the CPU 21 returns to step S101. Specifically, the CPU 21 continues the workflow production operation until the workflow has been produced.

The CPU 21 determines in step S104 whether the user has input an instruction for one piece of the workflow data 62 and the output data 64 displayed on the display 35. If the CPU 21 determines that the user has input the instruction for one piece of the workflow data 62 and the output data 64 displayed on the display 35 (yes in step S104), the CPU 21 performs the change operation to change the other piece of the workflow data 62 and the output data 64 displayed on the display 35 (step S105) and then ends the process.

Upon determining that the user has not input the instruction for the one piece of the workflow data 62 and the output data 64 displayed on the display 35 (no in step S104), the CPU 21 repeats step S104.

The input instruction to be input to the workflow includes, for example, a selection instruction to select one from multiple treatment steps. Specifically, the treatment step is selected by the user who performs a click operation on the displayed treatment steps. When the treatment step is selected in this way, the CPU 21 performs the change operation to change the print image of the output data 64 to a print image obtained when steps to the selected treatment step have been performed.

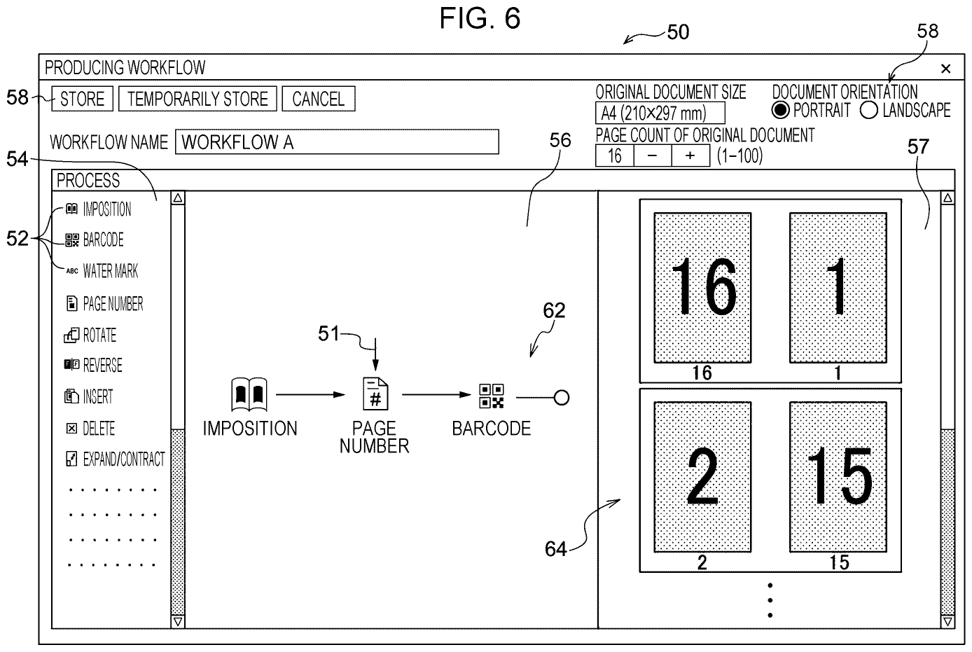

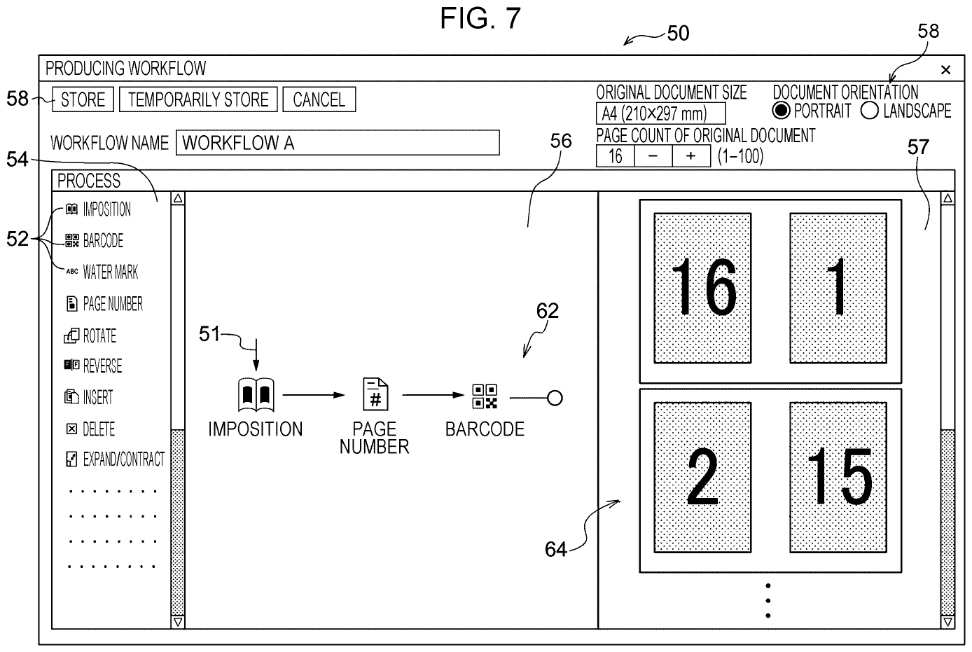

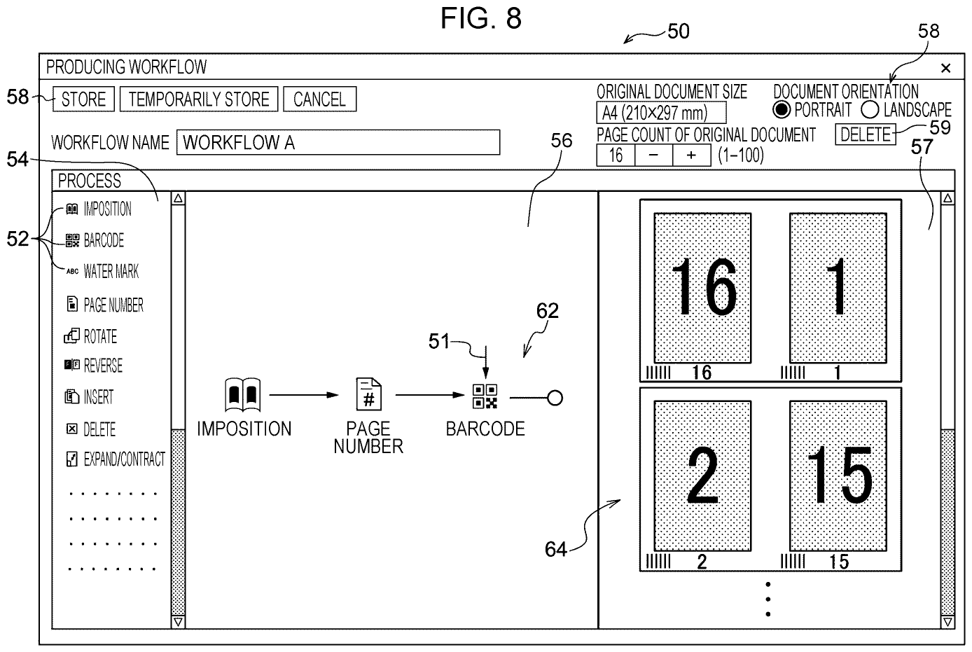

The selected treatment step is indicated by an arrow mark 51 or the like as illustrated in FIGS. 6 and 7. The selection instruction may be an instruction that simply selects the treatment step using the click operation or an instruction that simply selects the treatment step followed by confirming the selection.

In the example illustrated in FIG. 6, the output data display region 57 displays the print image that has undergone the procedure including the imposition step and page number attachment step with the page number attachment step selected by the user. Specifically, the output data display region 57 displays the print image before the barcode attachment step is performed.

In the example illustrated in FIG. 7, the output data display region 57 displays the print image that has undergone the procedure including the imposition step with the imposition step selected by the user. Specifically, the output data display region 57 displays the print image before the page number attachment step is performed.

The input instruction to be input for the output data 64 includes, for example, an edit instruction that edits the workflow. The edit instruction may be a processing instruction that processes the print image of the output data 64. Specifically, the processing instructions are an instruction to perform imposition, instructions to attach the barcode, watermark and page number to the print image and instructions to rotate, reverse, insert, delete and expand/contract a predetermined page of the print image.

When the edit instruction is input, the CPU 21 performs as the change operation an edit operation to edit the workflow in response to the edit instruction. When the processing instruction is input, the CPU 21 adds to the workflow as the change operation a treatment step that performs processing related to an add instruction.

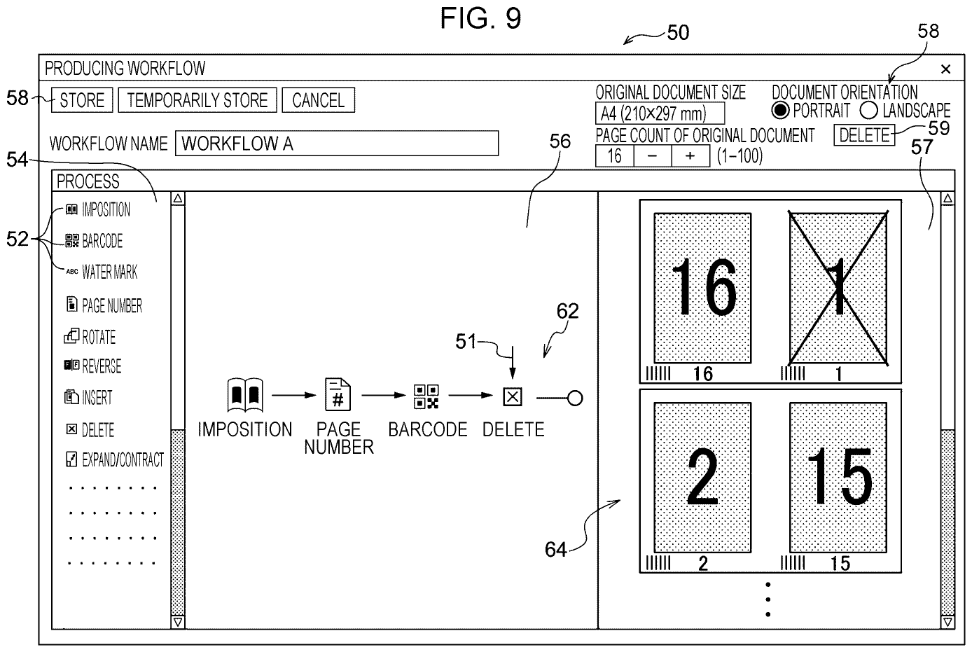

In the example illustrated in FIGS. 8 and 9, the user has input a delete instruction to delete the first page of the print image. For example, the user may press a delete button 59 (see FIG. 8) after selecting a target page (the first page in the example herein) of the print image. In this way as illustrated in FIG. 9, the first page of the print image of the output data 64 is thus deleted. In conjunction with this operation, the delete step is added to the workflow.

As illustrated in FIG. 9, the delete step is added after the treatment step selected in the workflow (the barcode attachment step denoted by the arrow mark 51 in FIG. 8). The print image having undergone the procedure to the delete step is displayed in the output data display region 57 and the treatment step denoted with the arrow mark 51 is accordingly changed to the delete step.

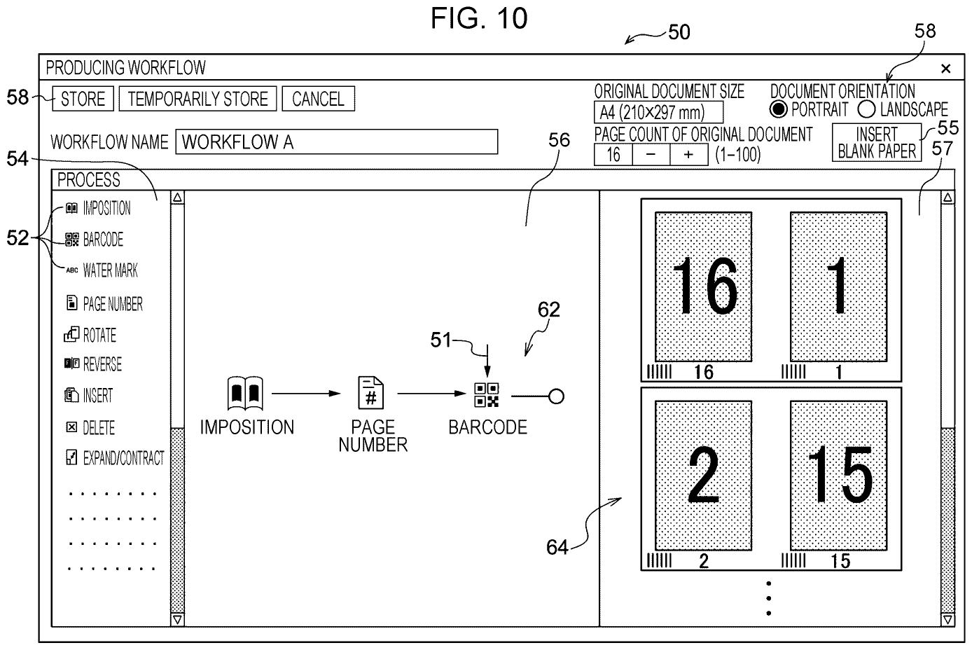

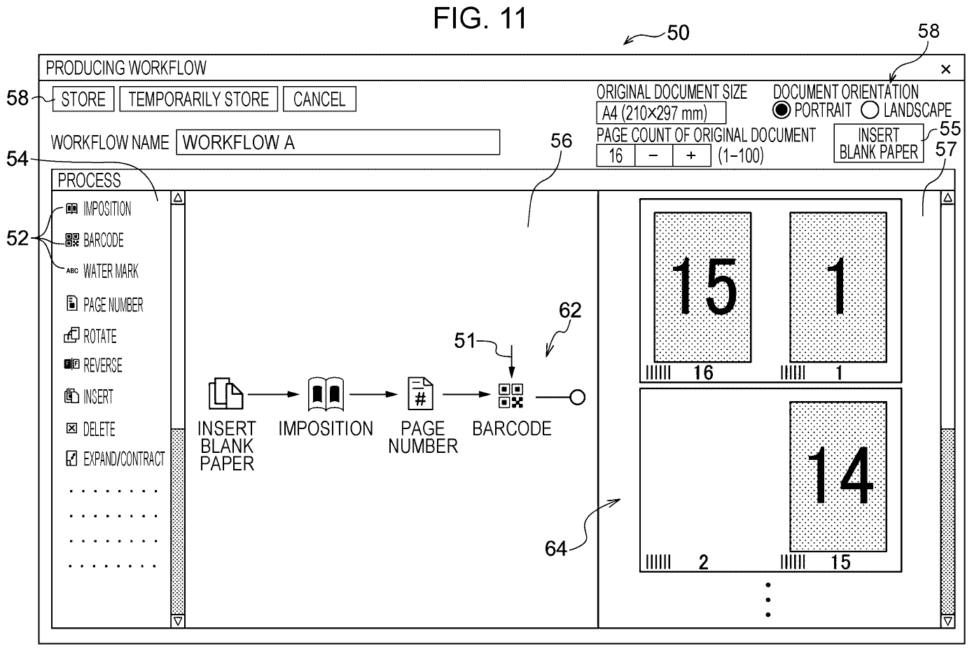

In the example illustrated in FIGS. 10 and 11, the user has provided an insert instruction to insert blank paper subsequent to the first page of the print image. For example, the user presses a blank paper insertion button 55 (see FIG. 10) after selecting the target page (the first page herein) of the print image. As illustrated in FIG. 11 in this way, the blank paper is inserted subsequent to the first page of the print image of the output data 64. In conjunction with this operation, a blank paper insert step is added to the workflow.

The blank paper insert step is to be performed prior to the imposition step and is thus added prior to the imposition step in the workflow as illustrated in FIG. 11. The previewed print image of the output data 64 includes the blank paper subsequent to the first page and the second and subsequent pages are displayed out of alignment.

The edit operation is not limited to adding the treatment step and may include deleting or replacing the treatment step.

When an edit instruction unable to edit the workflow is input for the output data 64, the CPU 21 may keep the workflow. The CPU 21 may furthermore display on the display 35 information (for example, warning indication) indicating that editing related to the edit instruction is unfeasible.

The edit instruction unable to edit may be an instruction to edit the treatment step that is prohibited on the output data 64 or an instruction to attach a barcode or watermark on the print image where no space is available.

The input instruction that is input for the output data 64 includes, for example, a change instruction that changes the position of an image on the print image of the output data 64. Specifically, the input instruction may be an instruction to change the positions of the barcode, watermark and page number attached to the print image. The input action to change the position of the image may be a drag and drop operation using a mouse or the like.

In the case described above, the CPU 21 performs the change operation that changes the position setting of the image in response to the processing instruction in the workflow.

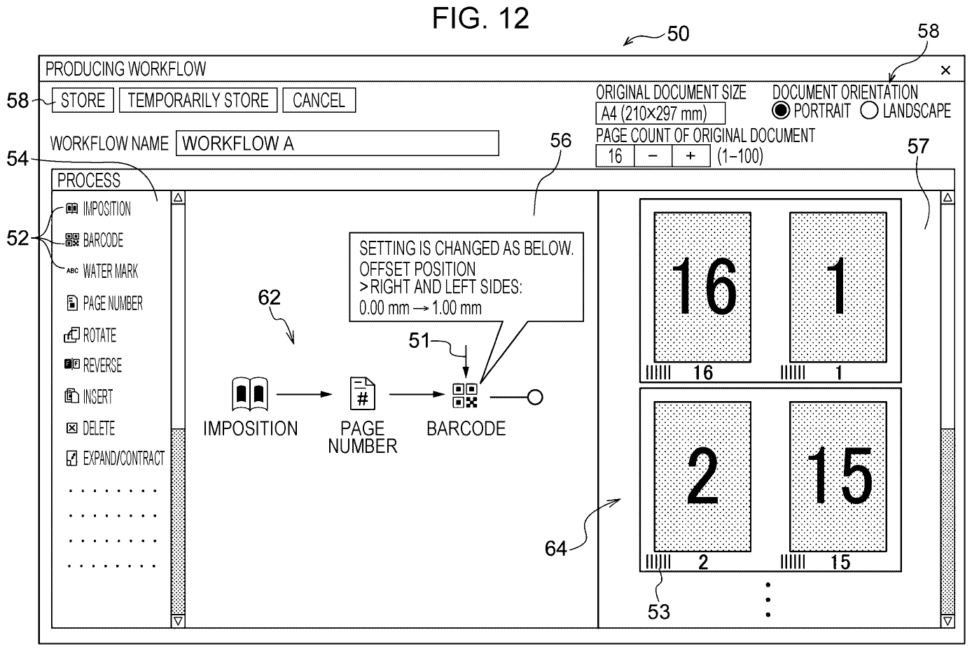

In the example illustrated in FIG. 12, the user provides an instruction to change the position of the barcode 53. For example, the user moves the barcode 53 by performing the drag and drop operation using the mouse or the like. In this way as illustrated in FIG. 12, the setting on the barcode attachment step is thus changed. The contents of the setting change may be displayed by popup.

When the change instruction to change to the position to which the image is not movable, the CPU 21 may keep the setting change in the workflow. The CPU 21 may further display on the display 35 information (such as warning indication) indicating that the position change related to the change instruction is unfeasible.

The input instruction to be input for the output data 64 may be, for example, an instruction to delete part of an image with respect to the print image of the output data 64. Specifically, an instruction to delete part of page numbers attached to the print image may be contemplated.

In such a case, the CPU 21 performs a change operation that changes in response to a processing instruction the position where the image is attached.

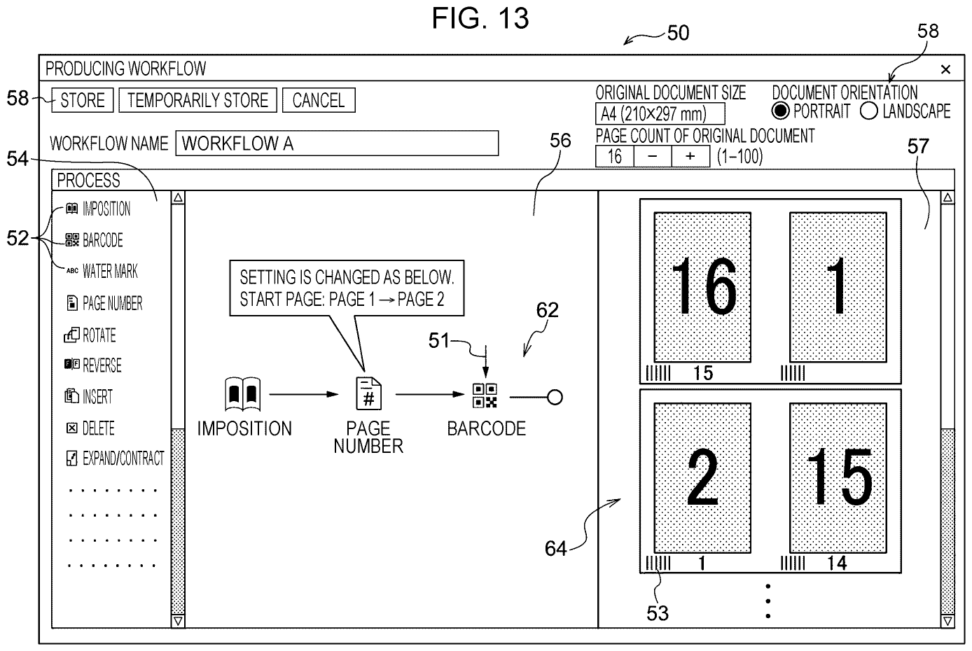

Referring to FIG. 13, the user provides an instruction to delete the page number on the first page of the print image. Specifically, the start page of the page number is changed to page 2 in FIG. 13. For example, the user selects the page number via a click operation and performs an operation to delete the page number. Referring to FIG. 13, the setting on the page number attachment step is changed. The contents of the setting change may be displayed using popup.

### Process of Exemplary Embodiment

According to the exemplary embodiment, as described above, when the instruction is input for the one piece of the workflow data 62 and the output data 64 displayed on the display 35, the CPU 21 changes the other piece of the workflow data 62 and the output data 64 in conjunction with the inputting.

In comparison with the case in which the other piece of data is not changeable unless the instruction is input for the one piece of the workflow data 62 and the output data 64, the other piece of the workflow data 62 and the output data 64 displayed on the display 35 may be easily changeable while confirming the one piece of the workflow data 62 and the output data 64.

According to the exemplary embodiment, when an edit instruction to edit the workflow on the output data 64 displayed on the display 35 is input, the CPU 21 edits the workflow in response to the edit instruction in conjunction with the inputting.

In comparison with the case in which the workflow is unable to be edited unless the edit instruction is input to the workflow displayed on the display 35, the workflow may be easily edited while the output data 64 displayed on the display 35 is confirmed.

According to the exemplary embodiment, when the processing instruction to process the print image is input for the output data 64 displayed on the display 35, the CPU 21 may add the treatment step to perform processing related to the processing instruction to the workflow in conjunction with the inputting.

In comparison with the case in which the treatment step to perform processing related to the processing instruction is unable to be added to the workflow unless the processing instruction is input to the workflow displayed on the display 35, the treatment step to perform processing related to the processing instruction may easily be added to the workflow while the output data 64 displayed on the display 35 is confirmed.

According to the exemplary embodiment, the CPU 21 may keep the workflow when the edit instruction that is unable to edit the workflow is input to the output data 64 displayed on the display 35.

In comparison with the case in which the CPU 21 changes the workflow when the edit instruction unable to edit the workflow is input to the output data 64 displayed on the display 35, the user may easily recognize that the edit instruction unable to edit the workflow has been input.

According to the exemplary embodiment, when the edit instruction unable to edit the workflow has been input to the output data 64, the CPU 21 may display on the display 35 information indicating that editing related to the edit instruction is unfeasible.

In comparison with the case in which the CPU 21 simply keeps the workflow when the edit instruction unable to edit the workflow is input to the output data 64, the user may easily recognize that the edit instruction unable to edit the workflow has been input.

According to the exemplary embodiment, when the processing instruction to change the position of the image has been input to the print image of the output data 64 displayed on the display 35, the CPU 21 changes the setting of the position of the image in response to the processing instruction in the workflow in conjunction with the inputting.

In comparison with the case in which the position setting of the image is unable to be changed in response to the processing instruction unless the processing instruction to the position of the image has been input to the workflow, the position setting of the image may be easily changed in the workflow while the print information displayed on the display 35 is confirmed.

According to the exemplary embodiment, when a selection instruction to select one of the treatment steps has been input to the workflow displayed on the display 35, the CPU 21 changes the print image of the output data 64 to the print image obtained when the procedure to the treatment step selected in the selection instruction is performed.

In comparison with the case in which the print image of the output data 64 displayed on the display 35 is unable to be changed to the print image obtained when the procedure to the processing step selected by the selection instruction is performed unless the selection instruction is input to the output data 64 displayed on the display 35, the print image of the output data 64 displayed on the display 35 may be easily changed to the print image obtained when the procedure to the processing step selected by the selection instruction is performed while the output data 64 is confirmed.

### Modifications

According to the exemplary embodiment, an example of the object includes but is not limited to the print image. For example, the example of the object may be a component forming part of a product and may be a thing that is manufacturable.

According to the exemplary embodiment, an example of a processed product includes but is not limited to the processed print image. The example of the processed product may be a product manufactured of a component and may be a thing that is manufacturable.

According to the exemplary embodiment, an example of the processing step includes but is not limited to a processing step related to printing. The example of the processing step may be a manufacturing step that manufactures a product and includes any processing step that may be performed on an object.

The disclosure is not limited to the above-described exemplary embodiments and a variety of changes, modifications and improvements are possible to the disclosure without departing from the scope of the disclosure. For example, the disclosure may be configured to appropriately combine multiple modifications described above.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the exemplary embodiments above, and may be changed.

The information processing system 10 in the exemplary embodiments may be configured to include a single apparatus or multiple apparatuses. The “system” in the exemplary embodiments may thus be configured to include a single apparatus or multiple apparatuses. The disclosure may be applicable to a program or a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An Information Processing System Including:
a processor configured to:
   display, on a display, procedure information indicating a processing procedure including multiple processing steps to process an object and processing-completion information indicating a product obtained when the processing procedure is performed on the object; and
   when an instruction is input for one piece of the procedure information and the processing-completion information displayed on the display, change, in conjunction with the inputting, the other piece of the procedure information and the processing-completion information displayed on the display.
(((2)))

In the information processing system according to (((1))), the processor is configured to, when an edit instruction to edit the processing procedure is input for the processing-completion information displayed on the display, edit in conjunction with the inputting the processing procedure of the procedure information displayed on the display in response to the edit instruction.
(((3)))

In the information processing system according to (((2))), the processor is configured to, when a processing instruction to process the object is input as the edit instruction for the processing-completion information displayed on the display, add in conjunction with the inputting a processing step related to processing indicated by the processing instruction to the processing procedure of the procedure information displayed on the display.
(((4)))

In the information processing system according to one of (((2))) and (((3))), the processor is configured to, when the edit instruction unable to edit the processing procedure is input for the processing-completion information displayed on the display, keep the procedure information displayed on the display.
(((5)))

In the information processing system according to (((4))), the processor is configured to, when the edit instruction unable to edit the processing procedure is input for the processing-completion information displayed on the display, display, on the display, information indicating that editing related to the edit instruction is unfeasible.
(((6)))

In the information processing system according to one of (((1))) and (((2))), the procedure information indicates the processing procedure including the multiple processing steps to process a print image serving as the object, and
the processing-completion information is image information indicating a print image serving as the product when the processing procedure is performed on the print image serving as the object, and
the processor is configured to, when the edit instruction to edit the processing procedure is input for the print image displayed on the display, edit in conjunction with the inputting the processing procedure of the procedure information displayed on the display in response to the edit instruction.
(((7)))

In the information processing system according to (((6))), the processor is configured to, when a processing instruction to process an image is input as the edit instruction for the print image displayed on the display, add in conjunction with the inputting a processing step related to processing for the processing instruction onto the processing procedure of the procedure information displayed on the display.
(((8)))

In the information processing system according to (((7))), the processor is configured to, when the processing instruction to change a position of the image is input for the print image displayed on the display, change in conjunction with the inputting a position setting of the image in response to the processing instruction in the processing procedure of the procedure information displayed on the display.
(((9)))

In the information processing system according to one of (((1))) through (((8))), the processor is configured to, when a selection instruction to select one of the processing steps is input for the procedure information displayed on the display, change in conjunction with the inputting the product indicated by the processing-completion information displayed on the display to the product that has undergone procedure including the processing step selected by the selection instruction.
(((10)))

A program causing a computer to execute a process for processing information, the process including:
displaying, on a display, procedure information indicating a processing procedure including multiple processing steps to process an object and processing-completion information indicating a product obtained when the processing procedure is performed on the object; and
when an instruction is input for one piece of the procedure information and the processing-completion information displayed on the display, changing, in conjunction with the inputting, the other piece of the procedure information and the processing-completion information displayed on the display.

What is claimed is:

1. An information processing system comprising:
a processor configured to:
display, on a display, procedure information indicating a processing procedure including a plurality of processing steps to process an object and processing-completion information indicating a product obtained when the processing procedure is performed on the object; and
when an instruction is input for one piece of the procedure information and the processing-completion information displayed on the display, change, in conjunction with the inputting, the other piece of the procedure information and the processing-completion information displayed on the display.

2. The information processing system according to claim 1, wherein the processor is configured to, when an edit instruction to edit the processing procedure is input for the processing-completion information displayed on the display, edit in conjunction with the inputting the processing procedure of the procedure information displayed on the display in response to the edit instruction.

3. The information processing system according to claim 2, wherein the processor is configured to, when a processing instruction to process the object is input as the edit instruction for the processing-completion information displayed on the display, add in conjunction with the inputting a processing step related to processing indicated by the processing instruction to the processing procedure of the procedure information displayed on the display.

4. The information processing system according to claim 2, wherein the processor is configured to, when the edit instruction unable to edit the processing procedure is input for the processing-completion information displayed on the display, keep the procedure information displayed on the display.

5. The information processing system according to claim 4, wherein the processor is configured to, when the edit instruction unable to edit the processing procedure is input for the processing-completion information displayed on the display, display, on the display, information indicating that editing related to the edit instruction is unfeasible.

6. The information processing system according to claim 2, wherein the procedure information indicates the processing procedure including the plurality of processing steps to process a print image serving as the object, and
the processing-completion information is image information indicating a print image serving as the product when the processing procedure is performed on the print image serving as the object, and
wherein the processor is configured to, when the edit instruction to edit the processing procedure is input for the print image displayed on the display, edit in conjunction with the inputting the processing procedure of the procedure information displayed on the display in response to the edit instruction.

7. The information processing system according to claim 6, wherein the processor is configured to, when a processing instruction to process an image is input as the edit instruction for the print image displayed on the display, add in conjunction with the inputting a processing step related to processing for the processing instruction onto the processing procedure of the procedure information displayed on the display.

8. The information processing system according to claim 7, wherein the processor is configured to, when the processing instruction to change a position of the image is input for the print image displayed on the display, change in conjunction with the inputting a position setting of the image in response to the processing instruction in the processing procedure of the procedure information displayed on the display.

9. The information processing system according to claim 1, wherein the processor is configured to, when a selection instruction to select one of the processing steps is input for the procedure information displayed on the display, change in conjunction with the inputting the product indicated by the processing-completion information displayed on the display to the product that has undergone procedure including the processing step selected by the selection instruction.

10. A non-transitory computer readable medium storing a program causing a computer to execute a process for processing information, the process comprising:
displaying, on a display, procedure information indicating a processing procedure including a plurality of processing steps to process an object and processing-completion information indicating a product obtained when the processing procedure is performed on the object; and
when an instruction is input for one piece of the procedure information and the processing-completion information displayed on the display, changing, in conjunction with the inputting, the other piece of the procedure information and the processing-completion information displayed on the display.

11. An information processing method comprising:
displaying, on a display, procedure information indicating a processing procedure including a plurality of processing steps to process an object and processing-completion information indicating a product obtained when the processing procedure is performed on the object; and
when an instruction is input for one piece of the procedure information and the processing-completion information displayed on the display, changing, in conjunction with the inputting, the other piece of the procedure information and the processing-completion information displayed on the display.
